(19) United States
(12) Patent Application Publication
(10) Pub. No.: US 2005/0048231 A1
(43) Pub. Date: Mar. 3, 2005

(54) Glazing panels

(76) Inventor: Michael Morphet, Lancashire (GB)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/933,119

(22) Filed: Sep. 2, 2004

(30) Foreign Application Priority Data
Sep. 3, 2003 (GB) 0320572.1

(51) Int. Cl. E06B 3/26

(52) U.S. Cl. 428/34; 428/116

(57) ABSTRACT

A glazing panel comprises top and bottom layers either side of an open cell core such as a honeycomb structure. The panel may include additional layers for imparting performance enhancing properties, such as a solar control layer and an insulation layer.

### TECHNICAL FIELD OF THE INVENTION

This invention concerns glazing panels, particularly but not exclusively for use in glazing conservatory roofs.

### BACKGROUND OF THE INVENTION

Glazing for conservatory roofs can be of three different types, namely glass, polycarbonate and poly vinyl chloride. Glass can be used a single sheets but will more often be used in the form of expensive double glazed units. Polycarbonate glazing sheets generally have at least two layers connected by webs and more often have three layers connected by spaced webs forming elongate cells. Polyvinyl chloride glazing sheets are of a similar type to polycarbonate glazing sheets in terms of basic structure but are usually of greater depth and coupled together side by side.

With any of these types of glazing, there are various issues to be taken into account in their use, including their load bearing strength and hence the widths up to which they can be used, their thermal properties both in terms of heat retention in colder periods and heat reflection in warmer periods and their acoustic properties.

### SUMMARY OF THE INVENTION

An object of this invention is to provide an improved glazing sheet, especially for use in glazing conservatory roofs.

According to a first aspect of the present invention there is provided a glazing panel made of plastics material and comprising top, bottom and one or more intermediate layers connected by webs to form elongate cells and having cells and/or at least one layer treated to enhance one or more of acoustic, thermal, solar control and durability properties.

In one preferred embodiment of the first aspect of the invention, a glazing panel has cells lined with a solar control coating. Preferably, the solar control coating will be applied to a single layer of cells of the glazing panel. The solar control coating may be conveniently applied during extrusion of the glazing panels through the extrusion die. Alternatively, the solar control coating may be applied by a secondary process after extrusion of the glazing panel. Alternatively, a solar control coating may be applied to the top layer of the glazing panel. The solar control coating may be a metallized film or a reflective pigment.

In another preferred embodiment of the first aspect of the invention, a glazing panel has cells filled with insulation material. Preferably the insulation material will be applied to a single layer of cells of the glazing panel. Preferably the insulation material will contribute to acoustic and/or thermal properties of the glazing panel. The preferred insulation material will be translucent. Examples of suitable insulation material for use in this aspect of the invention include silica, aerogel, microfibres and glass fibres.

In yet another preferred embodiment of the first aspect of the invention, a glazing panel has one or more layers of performance enhancing material applied to one or more layers of the panel, especially the intended top layer. A layer of material may be added to enhance impact resistance and/or cleanability. Suitable materials for enhancing impact resistance and/or cleanability include ETFE/PVDF (polyethylenetetrafluoroethylene/polyvinylidenedifluoride), PC (polycarbonate), PET (polyestertetraphthalate) and PVC (polyvinylchloride). A layer of material may additionally or alternatively be added to enhance thermal and/or acoustic properties of the glazing panel. Suitable materials for enhancing thermal and/or acoustic properties include PE (polyethylene), PE foam and silicone. Where two or more additional layers are applied to a glazing panel according to a first aspect of the invention, it may be necessary to interpose between layers of dissimilar material a bonding layer.

Typically glazing panels according to the first aspect of the invention may be made of polycarbonate or PET.

According to a second embodiment of the invention there is provided a glazing panel made of plastics material and comprising top and bottom layers connected by a core comprising an open cell structure, the structure having its open ends covered by either the top or bottom layers, wherein cells or at least one layer are treated to enhance one or more of acoustic, thermal, solar control and durability properties.

Preferably the open cell structure of the panels of the second aspect of the invention is a honeycomb structure. Preferably cells of the honeycomb structure will shaped so that pieces of glazing may be cut without the need to orientate the shape in line with the sheet. Preferably, the honeycomb structure will have hexagonal, octagonal or square section cells. Honeycomb structures may offer improved light transmission through glazing panels by directing and reflecting light through the panels. The core material may be made of a material that is useful for blocking heat or infrared radiation, such as cellulose acetate.

In one preferred embodiment of the second aspect of the invention, a glazing panel has a solar control coating applied thereto. The solar control coating is preferably applied to the intended top layer of the glazing panel. The solar control coating may be a metallized film or a reflective pigment.

In another preferred embodiment of the second aspect of the invention, a glazing panel has cells filled with insulation material. Preferably the insulation material will contribute to acoustic and/or thermal properties of the glazing panel. The preferred insulation material will be translucent. Examples of suitable insulation material for use in this aspect of the invention include silica, aerogel, microfibres and glass fibres.

In yet another preferred embodiment of the second aspect of the invention, a glazing panel has one or more layers of performance enhancing material applied to one or more layers of the panel, especially the intended top layer. A layer of material may be added to enhance impact resistance and/or cleanability. Suitable materials for enhancing impact resistance and/or cleanability include ETFE/PVDF, PC, PET and PVC. A layer of material may additionally or alternatively be added to enhance thermal and/or acoustic properties of the glazing panel. Suitable materials for enhancing thermal and/or acoustic properties include PE, foam materials, such as PE foam, and silicone. Where two or more additional layers are applied to a glazing panel according to a second aspect of the invention, it may be necessary to interpose between layers of dissimilar material a bonding layer.

Typically glazing panels according to the second aspect of the invention may be made of polycarbonate or PET.

Glazing panels according to the second aspect of the invention may be made by thermally bonding top and bottom layers to the core by way of an interlayer of low melting point plastics material or glue.

It is envisaged that the core structure may provide sufficient strength for wider panels to be used in glazing a conservatory roof and hence fewer glazing bars may be needed. Aluminium glazing bars may themselves be incorporated into glazing panels of the invention either as structural members or even as decorative elements.

Metallized layers or coatings applied to glazing panels according to the invention may also provide a low emissivity (low e) surface, which may improve thermal performance of a structure including those glazing panels.

Adhesive layers of, for example EVA (ethylvinylacetate) copolymer, used in bonding panel layers or cores may also serve to improve acoustic properties of the panels by being a softer material than the materials of the layers or cores, such as PC or PET.

### BRIEF DESCRIPTION OF THE DRAWINGS

This invention will now be further described, by way of example, only, with reference to the accompanying drawings, in which:

FIG. 1 shows a first embodiment of the invention;

FIG. 2 shows a second embodiment of the invention;

FIG. 3 shows a third embodiment of the invention;

FIG. 4 is a plan view of a fourth embodiment of the invention; and

FIG. 5 is a side view of the embodiment of FIG. 4.

### DETAILED DESCRIPTION OF THE ILLUSTRATED EMBODIMENTS

Referring to FIG. 1 of the accompanying drawings, a glazing panel 10 extruded from PC or PET has a top layer 12, a bottom layer 14 and intermediate layers 16 connected by webs 18 to form elongate cells 20. To improve acoustic and/or thermal properties of the glazing panel a top layer of cells 20 are filled with translucent insulation material 22. The translucent insulation material may be of silica, aerogel, microfibres or of glass fibres. Possibly even a foamed insulation material may be used.

Turning to FIG. 2 of the accompanying drawings, a glazing panel 30 of the same basic structure as shown in FIG. 1 of the drawings has a top layer of cells coated internally with a solar control coating 32, which may be a metallized coating or a reflective pigment coating. The coating is applied either through the extrusion die or by means of a secondary process after extrusion of the panel. Alternatively, a solar control coating may be applied directly to the top layer of the glazing panel.

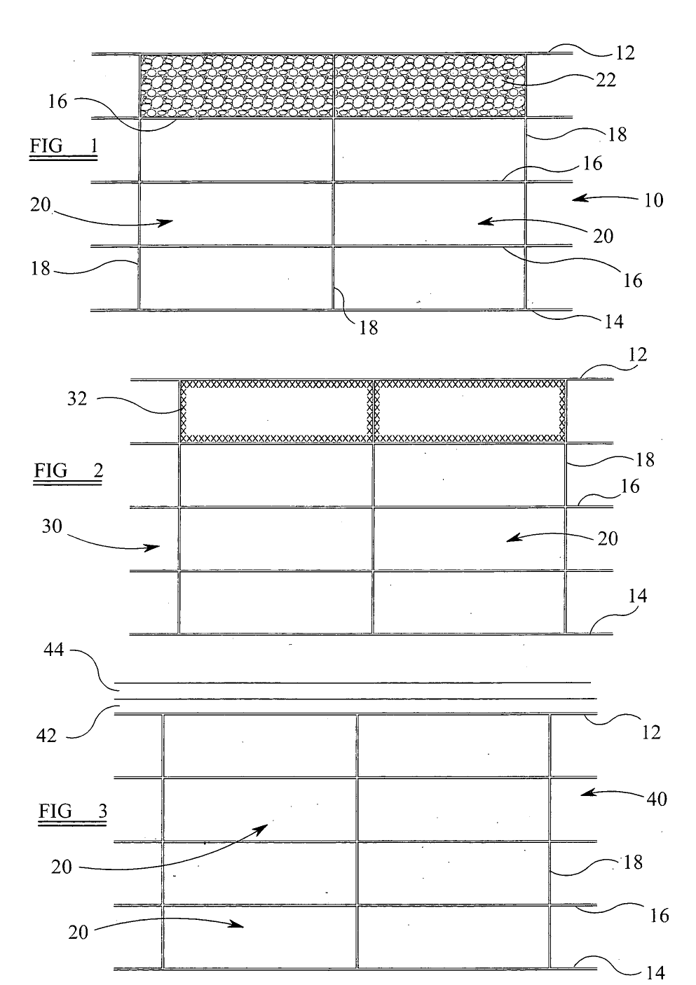

In FIG. 3 of the accompanying drawings, a glazing panel 40 again of the same basic structure as shown in FIG. 1 of the drawings has additional layers applied to the top layer 12. In this embodiment there is a first layer 42 of thermal and sound insulation enhancing material, such as of PE, PE foam or silicone, and a second layer of impact resistant material with cleanability properties, such as of ETFE, PVDF, PC, PET or PVC. These additional layers may be bonded directly to underlying layers or, where of dissimilar materials by means of bonding layers.

Whilst two specific types of additional layer have been described herein with reference to FIG. 3 of the drawings, it is envisaged generally that one or more layers of material may be applied to glazing panels of the same structural type as shown in FIG. 1 of the drawings to enhance any of the following properties, namely solar control, thermal, acoustic, cleanability, impact resistance and durability.

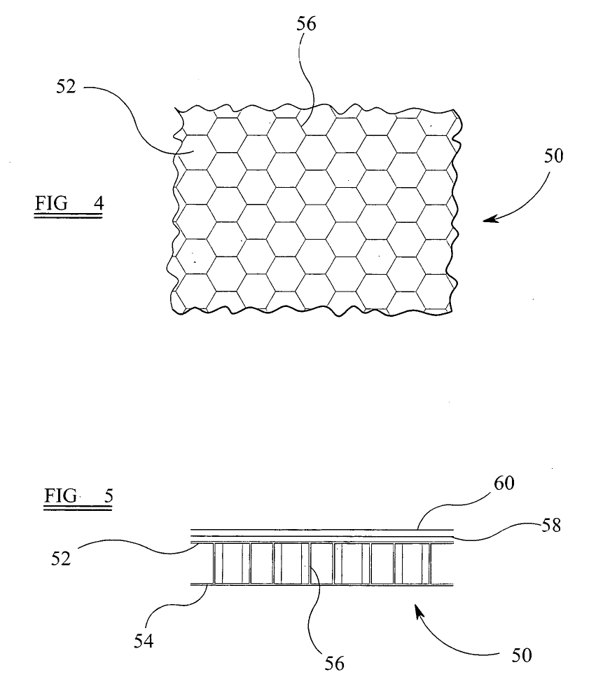

Turning to FIGS. 4 and 5 of the accompanying drawings, a glazing panel 50 comprises top and bottom layers 52 and 54 respectively either side of an open cell core 56 having a honeycomb structure. Glazing panels 50 may be made by thermally bonding top and bottom layers to the core by way of an interlayer of low melting point plastics material or glue.

The panel is shown with two additional layers 58, 60 applied thereto. The first layer 58 may be a solar control layer, such as a metallized film or a reflective pigment layer. The second layer 60 may be a layer of insulation material, such as of foam to improve thermal and/or acoustic properties of the glazing panel. Generally, one or more layers of material may be applied to the glazing panels 50 to enhance any of the following properties, namely solar control, thermal, acoustic, cleanability, impact resistance and durability.

Additionally or alternatively, the cells of the core structure may be filled with insulation material. Such insulation material is preferably translucent and may be of silica, aerogel, microfibres or of glass fibres. Possibly even a foamed insulation material may be used.

A typical panel 50 will have a thickness of about 33 mm in order to provide desirable thermal properties. The top and bottom layers will each be about 2 mm thick.

Panels 50 and of a similar type have advantages over conventional fluted polycarbonate glazing panels, which comprise top, bottom and intermediate layers connected by elongate webs. When such conventional fluted plastics panels have to be cut down to make say triangular shaped pieces, there is wastage of material, because care has to be taken to orient the flutes in a finished roof to match the flutes of the other panels making up the roof. With panels 50 and similar cutting down a panel is not so critical.

Secondly, the flutes of a conventional polycarbonate panel are open to the air and moisture and so can collect condensation. Apart from at edges of a panel, the cells of a panel 50 are not open to the atmosphere.

Thirdly, panels 50 can be much stronger than conventional polycarbonate panels withstand layer loadings from snow and wind. They may also be self-supporting and be usable over wider spans.

1. A glazing panel made of plastics material and comprising top, bottom and one or more intermediate layers connected by webs to form elongate cells and having one of the cells and at least one layer treated to enhance at least one of acoustic, thermal, solar control and durability properties.

2. A glazing panel as claimed in claim 1, wherein the panel has cells lined with a solar control coating.

3. A glazing panel as claimed in claim 2, wherein the solar control coating is applied to a single layer of cells of the panel.

4. A glazing panel as claimed in claim 1, wherein the solar control coating is applied to the top layer of the panel.

5. A glazing panel as claimed in claim 2, 3 or 4 wherein the solar control coating is selected from metallized films and reflective pigments.

6. A glazing panel as claimed in claim 1, wherein the panel has cells filled with insulation material.

7. A glazing panel as claimed in claim 6, wherein the insulation material is applied to a single layer of cells of the panel.

8. A glazing panel as claimed in claim 6, wherein the insulation material is translucent.

9. A glazing panel as claimed in claim 6, wherein the insulation material is selected from silica, aerogel, microfibres and glass fibres.

10. A glazing panel as claimed in claim 1, wherein the panel has at least one layer of performance enhancing material applied to at least one layer of the panel.

11. A glazing panel as claimed in claim 10, wherein the performance enhancing material is applied to the intended top layer.

12. A glazing panel as claimed in claim 10, wherein the material enhances at least one of impact resistance and cleanability.

13. A glazing panel as claimed in claim 12, wherein the performance enhancing material is selected from the group consisting of ETFE/PVDF (polyethylenetetrafluoroethylene polyvinylidenedifluoride), PC (polycarbonate), PET (polyestertetraphthalate) and PVC (polyvinylchloride).

14. A glazing panel as claimed in any one of the preceding claim 1, wherein the panel has at least one layer for enhancing at lease one of thermal and acoustic properties.

15. A glazing panel as claimed in claim 14, wherein the material for enhancing thermal and acoustic properties is selected from PE (polyethylene), PE foam and silicone.

16. A glazing panel as claimed in claim 1, wherein where at least two additional layers are applied to the panel, a bonding layer is interposed between the layers of dissimilar material.

17. A glazing panel as claimed in claim 16, wherein the bonding layer comprises EVA (ethylvinylacetate) copolymer.

18. A glazing panel as claimed claim 1, wherein the panel is made of polycarbonate or PET.

19. A glazing panel made of plastics material and comprising top and bottom layers connected by a core comprising an open cell structure, the structure having its open ends covered by either the top or bottom layers, wherein at least one of cells and at least one layer are treated to enhance at least one of acoustic, thermal, solar control and durability properties.

20. A glazing panel as claimed in claim 19, wherein the open cell structure is a honeycomb structure.

21. A glazing panel as claimed in claim 20, wherein the honeycomb structure has hexagonal, octagonal or square section cells.

22. A glazing panel as claimed in claim 19, wherein the core material blocks the transfer of at least one of heat and infrared radiation.

23. A glazing panel as claimed in claim 22, wherein the core material is cellulose acetate.

24. A glazing panel as claimed in claim 19, wherein a solar control coating is applied to the panel.

25. A glazing panel as claimed in claim 24, wherein the solar control coating is applied to the intended top layer.

26. A glazing panel as claimed in claim 24, wherein the solar control coating is selected from a metallized film and a reflective pigment.

27. A glazing panel as claimed in claim 19, wherein the glazing panel has cells filled with insulation material.

28. A glazing panel as claimed in claim 27, wherein the insulation material is applied to a single layer of cells of the panel.

29. A glazing panel as claimed in claim 27, wherein the insulation material is translucent.

30. A glazing panel as claimed in claim 29, wherein the insulation material is selected from silica, aerogel, microfibres and glass fibres.

31. A glazing panel as claimed in claim 19, wherein the panel has at least one layer of performance enhancing material applied to at least one layer of the panel.

32. A glazing panel as claimed in claim 31, wherein the performance enhancing material is applied to the intended top layer.

33. A glazing panel as claimed in claim 31, wherein the material enhances at least one of impact resistance and cleanability.

34. A glazing panel as claimed in claim 33, wherein the performance enhancing material is selected from the group consisting of ETFE/PVDF (polyethylenetetrafluoroethylene polyvinylidenedifluoride), PC (polycarbonate), PET (polyestertetraphthalate) and PVC (polyvinylchloride).

35. A glazing panel as claimed in claim 19, wherein the panel has at least one layer for enhancing at least one of thermal and acoustic properties.

36. A glazing panel as claimed in claim 35, wherein the material for enhancing thermal and acoustic properties is selected from PE (polyethylene), PE foam and silicone.

37. A glazing panel as claimed in claim 19, wherein where at least two additional layers are applied to the panel, a bonding layer is interposed between the layers of dissimilar material.

38. A glazing panel as claimed in claim 37, wherein the bonding layer comprises EVA (ethylvinylacetate) copolymer.

39. A glazing panel as claimed in claim 19, wherein the panel is made of one of polycarbonate and PET.

40. A glazing panel as claimed in claim 19, wherein the bottom and top layers are thermally bonded to the core by way of one of an interlayer of low melting point plastics material and glue.

41. A glazing panel as claimed in claim 1, wherein aluminium bars are incorporated into the glazing panel.

42. A glazing panel as claimed in claim 19, wherein aluminium bars are incorporated into the glazing panel.
